(19) United States
(12) Patent Application Publication
(10) Pub. No.: US 2023/0294139 A1
(43) Pub. Date: Sep. 21, 2023

(54) CLEANING APPARATUS FOR CLEANING, IN PARTICULAR DEGASSING, THERMOPLASTIC PLASTICS

(71) Applicant: "Eisbär" Trockentechnik GmbH, Götzis (AT)

(72) Inventor: Martin Spiegel, Dornbirn (AT)

(73) Assignee: "Eisbär" Trockentechnik GmbH, Götzis (AT)

(21) Appl. No.: 18/183,993

(22) Filed: Mar. 15, 2023

(30) Foreign Application Priority Data
Mar. 17, 2022 (AT) A70/2022

(51) Int. Cl. B08B 3/00; B29B 17/00

(52) U.S. Cl. CPC B08B 3/00; B29B 17/00; B08B 2230/01; B29B 2017/0015

(57) ABSTRACT

A cleaning apparatus for cleaning, in particular degassing, thermoplastic plastics, in particular polyolefins, the apparatus including a cleaning container for the thermoplastic plastic to be cleaned and a feed apparatus for feeding the thermoplastic plastic to be cleaned into the cleaning container in pourable form, the cleaning container having a gas feed opening, and a steam generator for generating water vapor being provided and being connected to the gas feed opening in order to feed the water vapor to the cleaning container.

### CROSS-REFERENCE TO RELATED APPLICATIONS

This application claims priority from Austrian Patent Application No. A70/2022, filed Mar. 17, 2022, which is incorporated herein by reference as if fully set forth.

### TECHNICAL FIELD

The present invention relates to a cleaning apparatus for cleaning, in particular degassing, thermoplastic plastics, in particular polyolefins, and also to a process for cleaning, in particular degassing, thermoplastics, in particular polyolefins.

### BACKGROUND

Apparatuses of the generic type contain a cleaning container for the thermoplastic to be cleaned and a feed apparatus for feeding the thermoplastic to be cleaned into the cleaning container in pourable, in particular free-flowing, form, the cleaning container having a gas feed opening.

The cleaning, in particular degassing, of thermoplastics is necessary in particular when recycled plastic which is intended for reuse is concerned. This is because for example when used as packaging material, the thermoplastic is of course exposed to the packaged articles and substances. When recycling the plastic, said recycling process causes odorous gases or other substances in the thermoplastic to go into solution, with the result that the recycled thermoplastic itself is also odorous or comprises other pollutants.

In order to counteract this, WO 2011/068717 A1 proposes contacting polyolefin chips with hot air for more than three hours. In this case, the hot air has a certain entrainment effect, as a result of which gases dissolved in the polyolefin chips are washed out. The thus treated polyolefin chips then have a relatively low odor nuisance.

This process from the prior art can be improved for a number of reasons. Firstly, the mentioned entrainment effect is rather ineffective, and so a lot of gas remains in the plastic.

Secondly, this has the effect that the process, as mentioned, takes at least three hours (up to 10 hours), and so a shortened process would of course be advantageous.

### SUMMARY

The object of the invention is to provide a cleaning apparatus and a process by which thermoplastic plastics can be cleaned more effectively, that is to say in particular more rapidly and/or more efficiently.

With regard to the cleaning apparatus, this object is achieved by an apparatus having one or more of the features disclosed herein, namely in that a steam generator for generating water vapor is provided and is connected to the gas feed opening in order to feed the water vapor to the cleaning container.

With regard to the process, the object is achieved by a process using one or more of the features disclosed herein, namely in that water vapor is generated, preferably using an apparatus according to the invention, and a thermoplastic plastic to be cleaned is exposed in pourable form to the water vapor.

The process according to the invention can be regarded as a production process for cleaned recycled thermoplastic plastic. Therefore, protection is also sought for such a process product, namely the cleaned recycled thermoplastic.

Furthermore, protection is sought for the use of a steam generator for generating water vapor when cleaning thermoplastic plastics, in particular polyolefins.

Surprisingly, it has been found that water vapor brings about a much better entrainment effect than hot air, and therefore the gases and other undesired substances present in the thermoplastic can be removed far more effectively (see, in this regard, FIG. 4), which also permits shorter dwell times.

Owing to the size of the water molecule per se, this was not really expected. It is assumed that the hydrogen atoms, which are part of the water molecule and are of course much smaller than nitrogen molecules present for example in the air, generate the entrainment effect according to the invention.

The cleaning apparatus according to the invention could also be referred to as steam cleaner.

It should be mentioned that the gas generator may be integrated in the cleaning container or may be embodied separately. The gas feed opening may then by way of example be through a transverse section of a vessel which contains or forms the cleaning container.

In the context of the invention, cleaning of thermoplastic plastics can be understood to mean removal of undesired substances from the thermoplastic plastics.

In the context of the invention, undesired substances, which according to the invention are to be removed from the thermoplastic plastics to be cleaned, are understood to mean those substances which are subjected, under the action of the water vapor, to an entrainment effect and which can, as a result, be at least partially removed from the thermoplastic plastics.

The undesired substances may preferably be gases which are to be removed (degassed) from the thermoplastic plastics to be cleaned (degassed). However, other substances, for example harmful substances which may for example be harmful to health and/or the environment, in particular liquids, may also be undesired substances within the meaning of the invention.

In the context of the invention, the fact that the thermoplastic plastic to be cleaned is present in pourable form can be understood to mean that the thermoplastic plastic, in comparison to the cleaning container, is present in small parts which can be conveyed into the cleaning container by means of customary transport apparatuses (for example vacuum conveyor, screw conveyor, etc.).

The thermoplastic plastics may particularly preferably be present as polymer materials.

Examples would be thermoplastic plastics in the form of pellets, granules and/or chips.

In preferred embodiments, the thermoplastic plastics may be present in free-flowing form, that is to say in such a form that the thermoplastic plastics can flow vertically and/or horizontally by itself for example under the action of gravity.

Further advantageous refinements of the invention are defined below and in the claims.

Preferably, a discharge apparatus for discharging the cleaned thermoplastic plastics from the cleaning container may be provided.

The feed apparatus and/or the discharge apparatus may comprise a rotary feeder and/or at least one shut-off valve.

The cleaning container may have a degassing opening for discharging water vapor together with gases that have escaped from the thermoplastic plastics.

The degassing opening may preferably be arranged on a top side of the cleaning container.

As an alternative or in addition, a degassing valve may be present, which can be used to influence a pressure and/or a volume flow of the exiting water vapor together with the gases that have escaped from the thermoplastic plastics.

A drying apparatus for the cleaned thermoplastic plastics may be connected downstream of the cleaning container. By way of example, air (for example hot air and/or cold air) can be used to remove moisture originating from the cleaning operation.

Provision may be made in this case for heat from the drying apparatus to be used for preheating the gas generator. For this purpose, a heat exchanger, by means of which water is heated, may be present in the drying apparatus, and the thus pre-heated water may be fed to the steam generator.

It should be mentioned that the temperature of the cleaned thermoplastic plastic may also be controlled by an air flow for drying, depending on the further use (for example relatively cold in the case of subsequent storage or subsequent transport or relatively warm in the case of subsequent extrusion).

The cleaning container may have a condensate opening for discharging condensed water—possibly together with (undesired) substances that have escaped from the thermoplastic plastic—from the cleaning container.

The condensate opening may preferably be arranged on a bottom side of the cleaning container.

As an alternative or in addition, a condensate valve may be present, which can be used to influence a pressure and/or a volume flow of the exiting water—possibly together with substances that have escaped from the thermoplastic plastic.

Provision may be made of an open-loop or closed-loop control device for open-loop or closed-loop control of at least one of the following: steam generator, feed apparatus, discharge apparatus, at least one valve at the degassing opening and/or at the condensate opening, in particular the degassing valve and/or the condensate valve.

A pressure sensor may be present, which can be used to detect a pressure in the cleaning container and/or at the degassing opening.

The pressure sensor may be signal-connected to the open-loop or closed-loop control device, such that signals of the pressure sensor can be used as fed-back variable for the open-loop and/or closed-loop control carried out by the open-loop or closed-loop control device.

The open-loop or closed-loop control device may in particular be configured such that the features formulated in terms of a process in the context of the invention, are implemented.

The thermoplastic plastic to be cleaned may be exposed to the water vapor which is present in substantially pure form.

Preferably, an entraining gas (for example in the cleaning container) for cleaning the thermoplastic plastic consist of water vapor to an extent of more than 80%, preferably more than 90%, particularly preferably more than 95%, and very particularly preferably more than 99%.

The thermoplastic plastic to be cleaned may be exposed to the water vapor for between 15 minutes and 240 minutes, preferably between 50 minutes and 210 minutes, and particularly preferably between 80 minutes and 180 minutes.

The water vapor may have a temperature of 90° C. to 150° C. when it is generated and/or when the thermoplastic plastic to be cleaned is exposed to it.

The process according to the invention may be carried out continuously, quasi-continuously or batchwise.

That is to say that, for example, the cleaning container can be filled with thermoplastic plastic to be cleaned, then the thermoplastic plastic to be cleaned can be exposed to the water vapor generated by the steam generator and be removed from the cleaning container (batchwise performance).

As an alternative, thermoplastic plastic to be cleaned can be refilled into the cleaning container, for example with a predefined frequency and/or a rotary feeder, while cleaned thermoplastic plastic is removed in an analogous manner synchronously or asynchronously from the cleaning container (quasi-continuous performance).

As an alternative, thermoplastic plastic to be cleaned can also be continuously refilled into the cleaning container and be continuously removed (continuous performance).

Mixed forms are also conceivable, for example continuous refilling and quasi-continuous removal.

As mentioned, these process steps can be implemented by means of the open-loop or closed-loop control device.

As already mentioned, the thermoplastic plastic to be cleaned may be present in the form of pellets and/or granules and/or flakes when the thermoplastic plastic to be cleaned is exposed to the water vapor.

Flakes may be produced, for example, when shredding plastic bottles.

Flakes may be present in the form of chips.

### BRIEF DESCRIPTION OF THE DRAWINGS

Further advantages and details of the invention will emerge from the figures and from the associated description of the figures. In the figures:

FIG. 1 shows an exemplary embodiment according to the invention of a cleaning apparatus for cleaning thermoplastic plastics,

FIG. 2 shows a further exemplary embodiment according to the invention of a cleaning apparatus for cleaning thermoplastic plastics,

FIG. 3 shows a further exemplary embodiment according to the invention of a cleaning apparatus for cleaning thermoplastic plastics, and

FIG. 4 shows a graph relating to the effectiveness of the process according to the invention.

### DETAILED DESCRIPTION

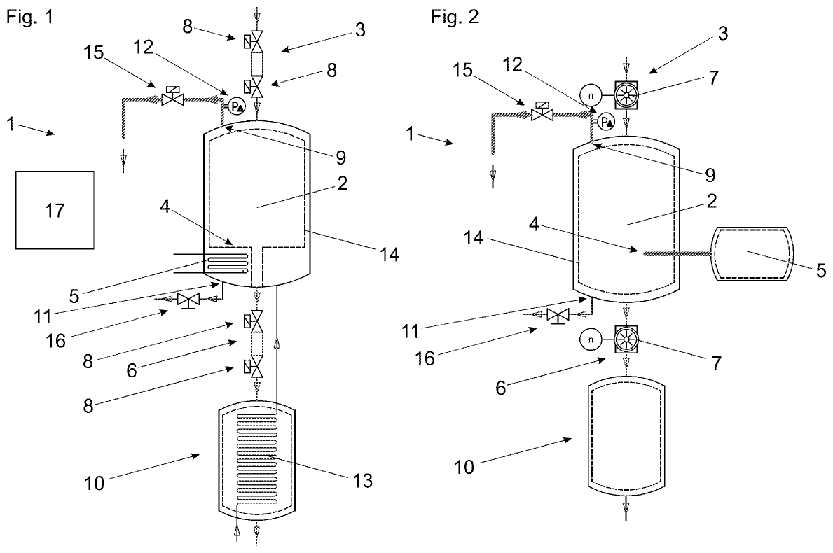

FIG. 1 shows an exemplary embodiment of a cleaning apparatus 1 for cleaning, in particular degassing, thermoplastic polymers.

In this exemplary embodiment, a cleaning container 2 and a steam generator 5 are arranged in a common container.

Specifically, in this exemplary embodiment, water, which is present in the lower part of the common container, is heated and evaporated as a result. In the present exemplary embodiment, the water is heated by way of a heating coil which has a heating current applied to it.

The resultant water vapor passes upward into the region of the cleaning container.

In this exemplary embodiment, the gas feed opening 4 is thus realized through a transverse section of the common container.

A lining 14 prevents the thermoplastic plastic, which is fed in for example in the form of granules, from passing into the region of the steam generator.

At the side walls and the upper part of the common container, the lining 14 may function as insulation.

In order to feed in the thermoplastic plastic, a feed apparatus 3 is provided on the top side of the cleaning container 2.

In this exemplary embodiment, the feed apparatus 3 comprises two shut-off valves 8 which are connected in series and which prevent advancing thermoplastic plastic from passing into the cleaning container 2.

Analogously, the discharge apparatus 6 likewise comprises two shut-off valves 8 which prevent cleaned thermoplastic plastic from passing out of the cleaning container 2 in an undesirable manner.

The cleaning apparatus 1 of this exemplary embodiment may be operated both batchwise and quasi-continuously.

For batchwise operation, the shut-off valves 8 of the feed apparatus 3 are first opened, such that thermoplastic plastic to be cleaned is filled into the previously empty cleaning container 2. After the cleaning container 2 has been filled in this way, the shut-off valves 8 of the feed apparatus 3 are closed and the cleaning operation begins.

Once the cleaning operation has concluded, the shut-off valves 8 of the discharge apparatus 6 can be opened, such that the cleaned thermoplastic plastic flows out of the cleaning container.

For quasi-continuous operation, use may be made of the fact that there is a certain volume present between the shut-off valves 8 of the feed apparatus and of the discharge apparatus, said volume being able to be used for metering.

If a certain quantity of thermoplastic plastic to be cleaned is to be fed in, the upper shut-off valve 8 of the feed apparatus 3 can first be opened, such that the mentioned volume fills with thermoplastic plastic to be cleaned.

Then, the upper shut-off valve 8 of the feed apparatus 3 is closed and the lower shut-off valve 8 of the feed apparatus 3 is opened, such that the quantity of thermoplastic plastic to be cleaned present in the mentioned volume passes into the cleaning container 2.

An analogous procedure can be performed with the discharge apparatus.

In this way, thermoplastic plastic can be cleaned successively and quasi-continuously in the cleaning container 2.

According to the invention, the actual cleaning operation is effected in that the thermoplastic plastic in the cleaning container 2 is exposed to the water vapor generated by the steam generator 5.

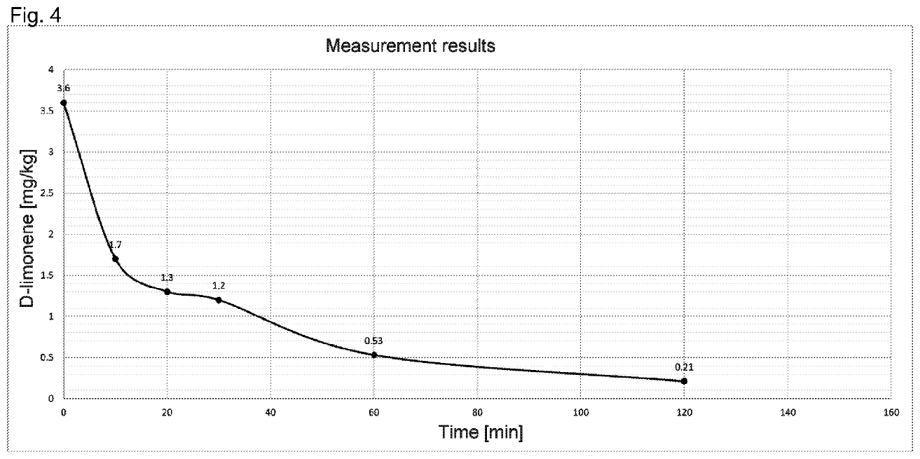

The thus improved effectiveness of the cleaning operation is described in more detail in conjunction with FIG. 4.

In the cleaning container 2, there is a degassing opening 9 via which water vapor together with gas removed from the thermoplastic plastic can exit the cleaning container 2.

A pressure sensor 12 and a degassing valve 15 are present in a line adjoining the degassing opening 9. The water vapor in the cleaning container 2 can, as a result, be kept at a desired pressure.

As an alternative or in addition, the pressure sensor 12 could also be provided in the cleaning container 2.

A condensate opening 11 is also present, by means of which condensed or not yet evaporated water can be discharged, possibly together with substances which have been removed by the cleaning according to the invention from the thermoplastic plastic and which are present in the condensed water.

A condensate valve 16, which can control the discharging of the condensate or of the not yet evaporated water together with the mentioned substances, is also present in a line adjoining this condensate opening 11.

Provided adjoining the discharge apparatus 6 is a drying apparatus 10 for drying the cleaned thermoplastic plastic.

In the present exemplary embodiment, the drying is effected by fed-in hot or cold air.

A heat exchanger 13 is also provided in the drying apparatus 10.

In this exemplary embodiment, the heat exchanger 13 is in the form of a meandering tube which leads through the drying apparatus 10 and which is connected to the steam generator 5.

Water is conducted through the heat exchanger 13 and preheated by the heat present in the drying apparatus 10. Said water then passes, in the preheated state, into the reservoir region of the steam generator 5.

An open-loop or closed-loop control device 17, which in this exemplary embodiment is signal-connected to the pressure sensor 12, the shut-off valves 8 of the feed apparatus 3 and of the discharge apparatus 6, the steam generator 5, the condensate valve and the degassing valve 15, is illustrated symbolically.

The open-loop or closed-loop control device 17 can actuate the feed apparatus 3 and the discharge apparatus 6 for batchwise or quasi-continuous operation, as has already been described to some extent further above.

Furthermore, the open-loop or closed-loop control device 17 can control a degree of opening of the degassing valve 15 and/or a steam generation capacity of the steam generator 5 on the basis of the measurement signals of the pressure sensor 12 in open-loop or closed-loop fashion.

It is of course also possible for further sensors, such as a temperature sensor and/or a fill level sensor, to be present, the measurement signals of which can be used for such open-loop or closed-loop control or other open-loop or closed-loop controls (for example of the condensate valve 16).

FIG. 2 shows a further exemplary embodiment of a cleaning apparatus 1.

A first difference between the cleaning apparatus 1 according to FIG. 1 and that according to FIG. 2 is that the steam generator 5 is embodied separately from the cleaning container 2.

As a result, the lining 14 may be completely in the form of insulation 14.

However, the basic functioning is analogous to that in FIG. 1, that is to say that undesired gases are washed out of the thermoplastic plastic by the water vapor.

A further difference between the cleaning apparatus 1 according to FIG. 1 and that according to FIG. 2 is that the feed apparatus 3 and the discharge apparatus 6 are implemented not by shut-off valves 8 but by rotary feeders 7.

In principle, this also allows both batchwise and quasi-continuous operation. However, the embodiment from FIG. 2 is preferably operated quasi-continuously.

That is to say that the rotary feeders 7 are used to refill thermoplastic plastic to be cleaned, and to remove cleaned thermoplastic plastic from the cleaning container 2, quasi-continuously.

As is indicated symbolically in this regard in FIG. 2, to this end the rotary feeders 7 may be rotated at a defined rotational speed n per hour.

In the embodiment according to FIG. 2, it would also be possible, in principle, for a preheating means for the steam generator 5 to be provided, said preheating means being fed with heat from the drying apparatus 10. However, this is not provided in the exemplary embodiment depicted in FIG. 2.

It should also be mentioned that the embodiment according to FIG. 2 also has an open-loop or closed-loop control device 17 which functions analogously, in particular actuates the rotary feeders 7 instead of the shut-off valves 8, but is not illustrated.

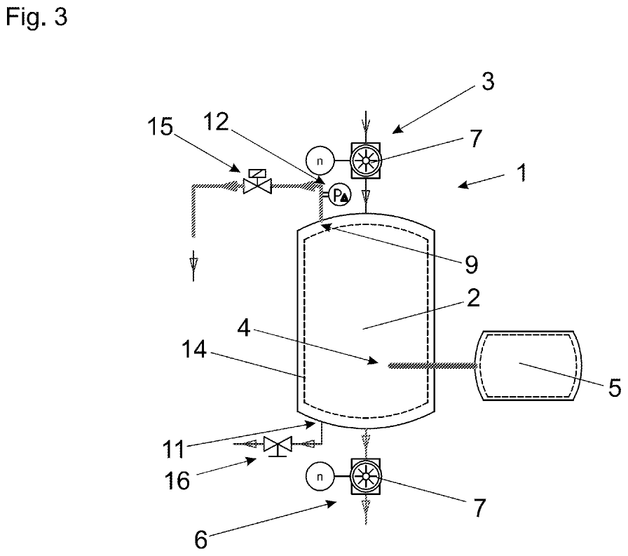

FIG. 3 shows an embodiment which is similar to that from FIG. 2, but with no drying apparatus 10 being provided. This means that the invention can be readily employed even without a drying apparatus 10.

It should be noted that the different elements of the embodiments described here may by all means be combined with one another in a different manner.

By way of example, it would also be possible for rotary feeders 7 to be used instead—or partially instead—of the shut-off valves 8 in the embodiment according to FIG. 1.

FIG. 4 shows a graph of a measurement relating to the effectiveness of the cleaning by means of water vapor according to the invention.

mg of D-limonene present per kg in the plastic is plotted versus the elapsed time for which the plastic was exposed to the water vapor.

D-limonene is usually used as measured value for the odor nuisance of plastics, because this compound is the most difficult to remove from the plastic and therefore is washed out of the plastic last.

As can clearly be seen from the graph from FIG. 4, the concentration of D-limonene in the plastic to be cleaned decreases very sharply at the beginning, that is to say that a large quantity of the gases and other substances to be removed is washed out at the beginning.

In fact, after approximately 15 minutes a concentration is already achieved that can only be achieved after three or more hours when degassing with hot air.

In addition, according to the invention, a dwell time of between one or two hours makes it possible to achieve much lower concentrations than with hot air, while a time advantage is still provided.

As already mentioned, other gases and/or other undesired substances are removed from the thermoplastic plastic more rapidly than the mentioned D-limonene.

It should also be pointed out that the exemplary embodiments shown may by all means be used in a greatly modified manner. By way of example, it is not necessary for the feed direction for the thermoplastic plastic to be directed vertically downward. If suitable conveying apparatuses are provided, it is for example also possible to implement a horizontal feed.

Nor is it necessary for the thermoplastic plastic to always be strictly separated from the liquid phase.

The water vapor to which the thermoplastic plastic to be cleaned is exposed does not have to, as mentioned, be 100% pure. In principle, it would also be conceivable to provide the water vapor with a desired odor component. However, in preferred exemplary embodiments, the water vapor is as pure as possible in order to obtain as odor-neutral a process product as possible.

### LEGEND TO THE REFERENCE SIGNS

1 Cleaning apparatus

2 Cleaning container

3 Feed apparatus

4 Gas feed opening

5 Steam generator

6 Discharge apparatus

7 Rotary feeder

8 Shut-off valve

9 Degassing opening

10 Drying apparatus

11 Condensate opening

12 Pressure sensor

13 Heat exchanger

14 Lining/insulation

15 Degassing valve

16 Condensate valve

17 Open-loop or closed-loop control device.

1. A cleaning apparatus for cleaning thermoplastic plastics, the cleaning apparatus comprising:
a cleaning container for the thermoplastic plastic to be cleaned;
a feed apparatus for feeding the thermoplastic plastic to be cleaned into the cleaning container in pourable form;
the cleaning container having a gas feed opening; and
a steam generator for generating water vapor connected to the gas feed opening in order to feed the water vapor to the cleaning container.

2. The cleaning apparatus as claimed in claim 1, further comprising a discharge apparatus for discharging the cleaned thermoplastic plastic from the cleaning container.

3. The cleaning apparatus as claimed in claim 2, wherein at least one of the feed apparatus or the discharge apparatus comprises at least one of a rotary feeder or at least one shut-off valve.

4. The cleaning apparatus as claimed claim 3, wherein the cleaning container has a degassing opening for discharging water vapor together with gases that have escaped from the thermoplastic plastic.

5. The cleaning apparatus as claimed in claim 1, further comprising a drying apparatus for the cleaned thermoplastic plastic connected downstream of the cleaning container.

6. The cleaning apparatus as claimed in claim 4, wherein the cleaning container has a condensate opening for discharging condensed water from the cleaning container.

7. The cleaning apparatus as claimed in claim 6, further comprising an open-loop or closed-loop control device for open-loop or closed-loop control of at least one of: the steam generator, the feed apparatus, the discharge apparatus, at least one valve at the degassing opening, or the condensate opening.

8. A process for cleaning thermoplastic plastics, the process comprising:
generating water vapor; and
exposing the thermoplastic plastic to be cleaned in pourable form to the water vapor.

9. The process as claimed in claim 8, wherein the thermoplastic plastic to be cleaned is exposed to the water vapor which is present in substantially pure form.

10. The process as claimed in claim 8, wherein the thermoplastic plastic to be cleaned is exposed to the water vapor for between 15 minutes and 240 minutes.

11. The process as claimed in claim 8, further comprising heating the water vapor to a temperature of 90° C. to 150° C. prior to exposure to the thermoplastic plastic to be cleaned.

12. The process as claimed in claim 8, wherein the thermoplastic plastic to be cleaned is provided as at least one of pellets, granules, or flakes when the thermoplastic plastic to be cleaned is exposed to the water vapor.

13. The process as claimed in claim 8, further comprising carrying out the continuously, quasi-continuously or batchwise.

14. The process of claim 8, wherein the thermoplastic plastic comprises polyolefins.

15. A cleaned recycled thermoplastic plastic formed by the process as claimed in claim 8.

16. The process of claim 8, further comprising generating the water vapor using a steam generator.
